(19) United States
(12) Patent Application Publication
(10) Pub. No.: US 2011/0040639 A1
(43) Pub. Date: Feb. 17, 2011

(54) DISTRIBUTING WEB-ACTIVATABLE CONTENT

(75) Inventors: William Horden Wiltshire, South Australia (AU); Barry James Porter, South Australia (AU); Marisa Maio Mackay, South Australia (AU); Scott Johnson, New South Wales (AU); Robert John Humphreys, South Australia (AU); Andrew John Gibki, South Australia (AU); Lui Iuliano Iuliano, South Australia (AU)

Correspondence Address: MICHAEL BEST & FRIEDRICH LLP, 100 E WISCONSIN AVENUE, Suite 3300, MILWAUKEE, WI, 53202, US

(73) Assignee: M.NET CORPORATION LIMITED, Adelaide, South Australia (AU)

(21) Appl. No.: 12/671,391

(22) PCT Filed: Jul. 31, 2008
(86) PCT No.: PCT/AU2008/001098

§ 371 Date: Nov. 3, 2010

(30) Foreign Application Priority Data
Jul. 31, 2007 (AU) 2007904106

(51) Int. Cl. G06Q 30/00; G06F 15/16; G06F 3/01

(52) U.S. Cl. 705/14.73; 709/218; 715/733

(57) ABSTRACT

A system (100) for creating web content that is activatable for delivery to a communications service (101) is closed. In one embodiment, the system includes an interface (102) for receiving content configuration information from a content provider (104) and an engine (106) for processing the content configuration information (102) to generate program code for distribution to one or more nodes (108) of a computer network (110). Each node (108) executes the program code to display, on execution of the program code, an activatable control to a content viewer (111). The program code is configured to respond to a content viewer (111) activating the control to receive a communications service identifier from the content viewer (111) and to initiate delivery of content to the identified communications service in accordance with the configuration information. A method of creating web content that is activatable for delivery to a communications service is also disclosed.

This international patent application claims priority from Australian provisional patent application no. 2007904106 filed on 31 Jul. 2007, the contents of which are to be taken as incorporated herein by this reference.

### FIELD OF THE INVENTION

The present invention relates to distributing web-activatable content. In a typical application the present invention may be used to distribute web-content that is activatable for delivery to mobile devices.

### BACKGROUND OF THE INVENTION

The World Wide Web (the “web”) or Internet has allowed computer users enhanced access to different varieties of media content and information via the use of their computers. Such content may be in the form of audio, music, television programs, sporting events, computer programs and advertising. Indeed, the amount and types of information that are now available via the Internet is enormous.

Typically, a user will use a computer, such as a desktop computer, to browse different web-sites, typically using an internet browser, to locate a web-site containing media content or information of interest to them. If the uniform resource locator of the web-site is not known to the user, the user may use an internet search engine (such as Yahoo) to try and locate web-sites containing the media content or information of interest.

Browsing or surfing the internet by using an internet protocol (IP) based networked computer to access media content or information, is relatively simple. First, such computers are usually configured with standard Web browser application software that enables a user to access web-sites readily. Second, the infrastructure underlying the connectivity between the computer and the Internet typically provides for low cost data communication. This is because the connection between the computer and the Internet typically involves a connection the between the computer and an internet gateway or router, without the use of an intermediate telecommunications carrier which often imposes higher data communication costs.

Unfortunately, accessing the internet using a mobile device (such as a mobile phone, or mobile laptop computer) via an intermediate telecommunications carrier or service, such as a PLMN or GPRS network, presents a number of difficulties. First, often web-sites do not have content that is suitable for, or compatible with, the small screens of hand-held and limited downloads. Frequently, the formats for standard Web browsers are not compatible with the various browsers provided with mobile devices. Second, using a mobile device to access the Internet can lead to significant increased costs for data communication, even though the data being accessed is the same as that which would be accessible via the LAN example. Accordingly, browsing or surfing the Internet using a mobile device can be expensive, particularly since the costs are often based on time or the amount of data downloaded.

As a result of the increased costs and, in the case of mobile phones and personal digital assistants (PDS), often because of the size or ease of use limitations of the user interface, users can be reluctant to use their mobile devices to “surf the web”. Thus, for example, a user may instead use a networked computer to locate a particular web-site containing media content or information of interest to them, and them email the details of that web-site to their mobile device, or simply enter the URL for the web-site into the device and store the link as a “favourite”.

Because of the reluctance of mobile device users to use mobile devices for web surfing, web-content content providers, such as advertisers, are often not able to take full advantage of web-based advertising campaigns. In particular, such reluctance dilutes the effectiveness of content providers to access viewers via other types of communications services through a web-based advertising campaign.

In addition, to the above, the ability of web content providers to control the appearance of their content on web-sites not under their control is somewhat limited.

It would be advantageous of web content providers, and especially web-based advertising content providers, were able to access and control delivery of web-originating content to other communication services.

The discussion of the background to the invention herein is included to explain the context of the invention. This is not to be taken as an admission that any of the material referred to was published, known or part of the common general knowledge as at the priority date of any of the claims.

### SUMMARY OF THE INVENTION

The present invention provides a system for creating web content that is activatable for delivery to a communications service, the system including:

an interface for receiving content configuration information from a content provider;

an engine for processing the content configuration information to generate program code for distribution to one or more nodes of a computer network, each node for executing the program code to display, on execution of the program code, an activatable control to a content viewer; and

wherein the program code is configured to respond to a content viewer activating the control to receive a communications service identifier from the content viewer and to initiate delivery of content to the identified communications service in accordance with the configuration information. The present invention also provides a computer readable media storing a computer software program, the computer software program being executable by a computer to cause the computer to be operable by a content provider to create web content that is activatable for delivery to a communications service device by:

providing an input interface receiving content configuration information from the content provider;

providing an engine for processing the configuration information to generate program code for distribution to one or more nodes of a network, each node for executing the program code to display, on execution of the program code, an activatable control to a viewer; and

wherein the program code is configured to respond to a viewer activating the control to receive a communications service identifier from a viewer and to initiate delivery of content to the identified communications service in accordance with the content configuration information.

In an embodiment, the interface is a web portal, such as web portal associated with a web service.

The content configuration information may include information identifying or representing content for delivery to mobile devices. For example, the content configuration information may identify or represent content such as one or more of:

a. text content, in the form of a text message;

b. audio content;

c. graphical content; and

d. audio visual content.

The content configuration information may include a message for delivery to a device associated with the identified communications service. The characteristics and protocol of the message will typically depend on the identified communications service.

In an embodiment, the content configuration information includes computer program code for communication to a device associated with the identified communications service for execution by the device.

In an embodiment, the content configuration information includes link information identifying a web page. The link information may include, for example, a uniform resource locator (URL) information identifying a web page.

In an embodiment, the content configuration information includes information specifying business rules associated with the delivery of the web content to mobile devices. Such business rules may specify, for example, a limit on the number of times a control can be activated, or a cap on the cost associated with delivering the content to the identified communications service. The limit on the number of times a control can be activated may be, for example, a daily limit. In an embodiment, after the limit has been reached or exceeded the activatable control is disabled or deactivated, for example, by inhibiting the display of the control. In other example, the business rules may specify content delivery handling constraints, such as by preventing delivery of content to an identified device after the limit has been reached or exceed. For example, a content provider (such as an advertiser) may set a limit on the number of times that content may be delivered each day. When the daily limit has been reached the activatable control disappears from the webpage and a content viewer is prevented from accessing the control.

Each node of the computer network will typically include a browser for executing the program code. Any suitable browser may be used, including, for example, Microsoft® Internet Explorer, Mozilla Firefox and the like. In an embodiment in which each node of the computer includes a browser, the execution of the program code will appends the activatable control to a web page displayed by the browser. That web page may be for example, a web page generated by a web based search engine, such as Yahoo!®, Google® or similar. Alternatively, the web page may be another type of web page, such as a web page of a web-based on-line catalogue, an e-commerce site (such as a finance or retail site), a news site, or a blog site.

In an embodiment, the program code is configured to generate an input entry interface for receiving the communications service identifier in response to the viewer activating the control. The input entry interface may include, for example, a web pop-up.

The input entry interface may be configured to receive an “opt-in” selection signal from the viewer. In an embodiment, the opt-in selection signal is processed and stored by a management server and used to initiate automatic delivery of content to the identified communications service that may be of interest to the content viewer.

In an embodiment, the content delivered to the identified communications service is configured to be executable or interpretable by a device associated with the communications service so as to activate the content for output. For example, the content may include a script or program that is executable or interpretable by the device to thereby generate output content. In one example, the delivered content is a Java® game. However, the content may also include a web-page, a mobile coupon, an advertisement, a message, a URL, a program code for an executable application, a Really Simple Syndication (RSS) feed, an image file item, an audio file item, or a mobile social network client. In an embodiment in which the content includes a message, the message may be of any suitable type, and may include, for example, a short message service (SMS) message, a multi-media service (MMS) message or an email message.

The identified communications service may include one of:

a. a public land mobile network service (PLMN);

b. a public switched telephone network service (PSTN); and

c. a packet-switched based communications service.

As will be appreciated, different communication services also provide different services. Thus, for example, a PLMN service will typically be identified via a mobile phone number and may provide services such as a mobile telecommunications service, an short message service (SMS), or a wireless application protocol (WAP) service. Similarly, a PSTN may provide, for example, a voice telecommunications service or a data communications service (such as a facsimile service). It will also be appreciated that a packet-switched a packet based communications may include, for example, a general purpose radio service (GPRS), a 3G service or a wireless internet service.

The present invention also provides a method of creating web content that is activatable for delivery to a communications service, the method including:

an input interface receiving content configuration information from a content provider; and

an engine processing the configuration information to generate program code for distribution to one or more nodes of a network, each node for executing the program code to display, on execution of the program code, an activatable control to a viewer;

wherein the program code is configured to respond to a viewer activating the control to receive a communications service identifier from the viewer and to initiate delivery of content to the identified communications service device in accordance with the content configuration information.

In one embodiment, the computer network is an ad network. Thus, the present invention also provides a system for distributing web originating content to nodes of a computer ad network, the web content being activatable for delivery to an identified mobile communications service, the system including:

a web portal for creating web content in the form of an advertisement for delivery to a mobile device associated with a mobile communications service, the web portal including:
an interface for receiving content configuration information from a content provider;
an engine for processing the content configuration information to generate program code for distribution to one or more nodes of the ad network, each node for executing the program code to display, on execution of the program code, an activatable control to a viewer; and
wherein the program code is configured to respond to a viewer activating the control to receive, from the viewer, a mobile communications service identifier for a mobile device associated with the mobile communications service, and to initiate delivery of the advertisement to the mobile device service in accordance with the configuration information; and

one or more network nodes for receiving the program code, each node including a browser for executing the program code.

In a system embodiment, the engine may be a client side engine or a server side engine.

The present invention also provides a client computer including a processor, an associated memory, and a computer software program resident in the memory, the computer software program being executable by the processor to cause the computer to be operable by a content provider to create web content that is activatable for delivery to a communications service by:

providing an input interface for receiving content configuration information from the content editor;

providing an engine for processing the configuration information to generate program code for distribution to one or more nodes of a network, each node for executing the program code to display, on execution of the program code, an activatable control to a viewer; and
wherein the program code is configured to respond to a viewer activating the control to receive a communications service identifier from a viewer and to initiate delivery of content to the identified communications service in accordance with the content configuration information.

The present invention also provides a server computer including a processor, an associated memory, and a computer software program resident in the memory, the computer software program being executable by the processor to cause the computer to be operable by a content provider to create web content that is activatable for delivery to a communications service by:

receiving content configuration information from a client computer operated by a content editor;

providing an engine for processing the configuration information to generate program code for distribution to one or more nodes of a network, each node for executing the program code to display, on execution of the program code, an activatable control to a viewer; and

wherein the program code is configured to respond to a viewer activating the control to receive a communications service identifier from a viewer and to initiate delivery of content to the identified communications service in accordance with the content configuration information.

The present invention also provides a method of distributing web content that is activatable for delivery to a communications service, the method including:

an input interface receiving content configuration information from a content provider;

an engine processing the configuration information to generate program code for distribution to one or more nodes of a network, each node for executing the program code to display, on execution of the program code, an activatable control to a viewer; and

distributing the program code to one or more nodes of the computer network;

wherein the program code is configured to respond to a viewer activating the control to receive a communications service identifier from the viewer and to initiate delivery of content to the identified communications service device in accordance with the content configuration information.

### BRIEF DESCRIPTION OF THE DRAWINGS

The present invention will now be described in relation to various embodiments illustrated in the accompanying drawings. However, it must be appreciated that the following description is not to limit the generality of the above description.

In the drawings:

FIG. 1 is a block diagram of a system for creating web content that is activatable for delivery to a communications service according to an embodiment of the present invention;

FIG. 2 is a block diagram of an embodiment of a client computer suitable for incorporating in the system shown in FIG. 1;

FIG. 3 is a screen layout of a webpage suitable for use with the system shown in FIG. 1;

FIG. 4 is a flow diagram depicting a series of steps depicting functional steps performed by the system in processing content configuration information to generate program code for use with the system depicted in FIG. 1;

FIG. 5 is a flow diagram depicting a series of steps depicting functional steps performed by the system in distributing program code to a node of a computer network;

FIG. 6 is a screen layout of a webpage including an activatable control according to an embodiment of the present invention;

FIG. 7 is a screen layout of a pop-up window suitable for incorporating in an embodiment of the present invention;

FIG. 8A to 8C depict examples of content suitable for delivery to a mobile telephone;

FIG. 9 shows a data flow diagram for the steps of entering and processing content configuration information to provide modified a source file;

FIG. 10 shows a data flow diagram for the steps of displaying an activatable control on a network node; and

FIG. 11 shows a data flow diagram for the steps of displaying an activatable control on a network node;

All figures are drawn for ease of explanation of the basic teachings of the present invention only. The details of the figures with respect to number, position, relationship, and dimensions of the parts to form the illustrated embodiment will be explained, or will be within the skill of a person skilled of the art after the following description has been read and understood.

### DETAILED DESCRIPTION OF THE INVENTION

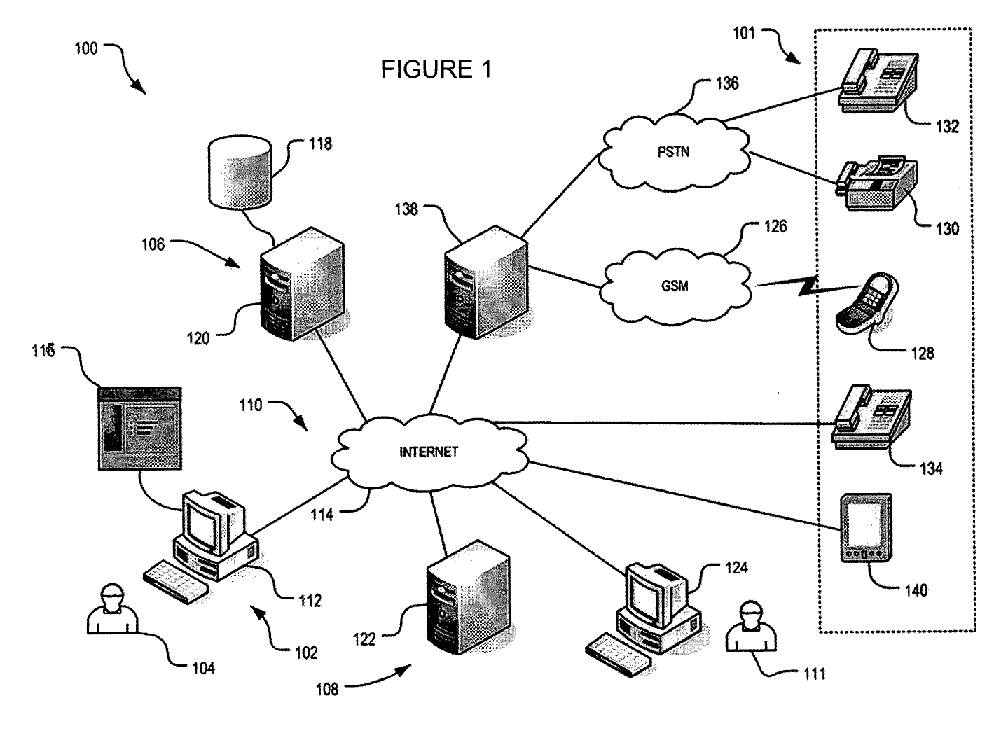

Referring to FIG. 1, there is shown a system block diagram for a system 100 for creating web content that is activatable for delivery to a communications service 101.

The system 100 includes an interface 102 for receiving content configuration information from a content provider 104, and an engine 106 for processing the content configuration information to generate program code for distribution to one or more nodes 108 (such as client computer 124) of a computer network 110.

As will be explained in more detail later, each node 108 is able to execute the program code to display an activatable control (not shown) to a content viewer 111. In addition, the program code is configured to respond to a content viewer 111 activating the control to receive a communications service identifier from the content viewer 111 and to initiate delivery of content to an identified communications service in accordance with the content configuration information.

The interface 102 includes a client computer 112 with a browser software application for accessing website data from the Internet 114 and displaying a webpage 116 to a content provider 104. The webpage 116 includes one or more pages of content encoded in a markup language, such as hypertext markup language (HTML), extensible markup language (XML), extensible hypertext markup language (XHTML) that can be interpreted by the browser application.

The client computer 112 may be a personal computer (PC), a hand-held computer, a laptop computer, a notebook computer, a personal digital assistant (PDS), a mobile personal communications device (such as a mobile phone) equipped with suitable operating system, or the like. In an embodiment, the client computer 112 is a computing device that includes an operating system and an Internet browser such as Microsoft Corporation's Internet Explorer.

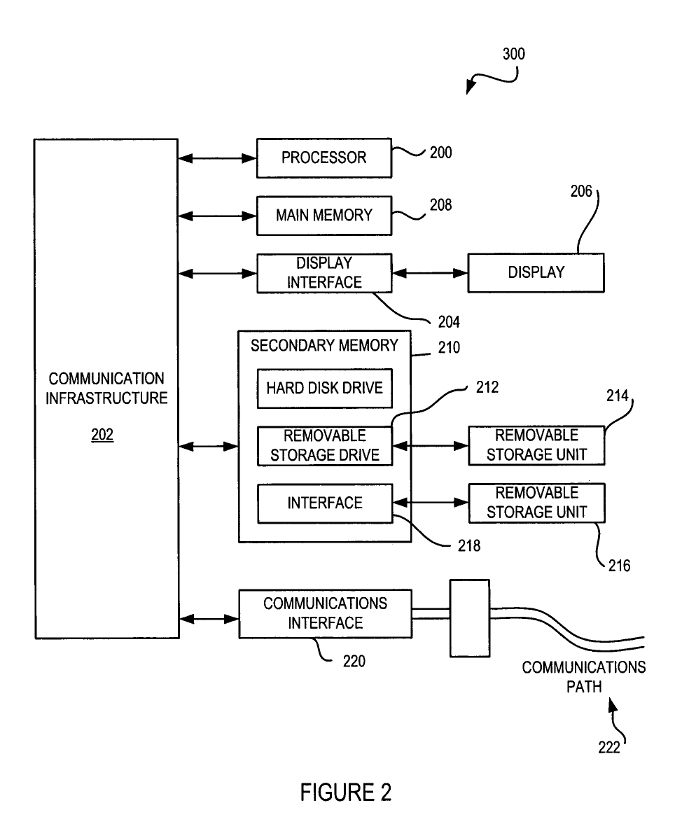

An exemplary client computer system 112 is shown in FIG. 2. The computer 112 shown here includes one or more processors, such as processor 200. The processor 200 is connected to a communications infrastructure 202. The computer 112 includes a display interface 204 that forwards text, graphics and other data from the communications infrastructure 202 for supply to a display unit 206, such as a video display unit (VDU). The computer system 112 may also include a main memory 208, preferably random access memory, and a secondary memory 210.

The secondary memory 210 may include, for example, a hard disc drive, a magnetic tape drive, an optical disc drive, RAM, ROM, EPROM, EEPROM, flash memory, CD-ROM, DVD, BD, Zip drive, or any other medium which can be used to store desired information and which can be accessed by the computer 112.

The removable storage drive 212 reads from and/or writes to a removable storage unit 214 in a well known manner. The removable storage unit 214 represents a floppy disc, magnetic tape, optical disc, or the like. As will be appreciated, the removable storage unit 214 includes a computer usable storage medium having stored therein computer software in the form of a series of instructions to cause the processor 200 to carry out desired functionality. In alternate embodiments, secondary memory 210 may include other similar means for allowing computer programs or instructions to be loaded into the computer 112. Such means may include, for example, a removable storage unit 216 (such as a universal serial bus drive) and an associated interface 218 (for example, a USB interface).

The computer 112 also includes a communications interface 220. The communications interface 220 allows software and data to be transferred between the computer system 112 and external devices, and may include a wired or wireless communications interface. By way of example, a suitable communications interface 220 may include a modem, a network interface (such as an Ethernet interface), a communications port (such as an RS232, RS422, a USB interface, or a Firewire interface) or the like. However, it should be appreciated by those skilled in the art that the communications interface may include any available interface that is compatible with the client computer 112.

Software and data transfer via the communications interface 220 may be in the form of signals which may be electronic, electromagnetic, optical or other signals capable of being received by the communications interface 220. The signals are provided to communications interface 220 via a communications path 222 such as by wire or cable, fibre optics, phone link, cellular phone link, radio frequency or other communications channels.

Returning now to FIG. 1, in the illustrated embodiment, to allow the client computer 112 to receive content configuration information from the content provider 104, the content provider 104 uses the client computer 112 to access a webpage 116 configured to permit the content provider 104 to enter the content configuration information. The webpage 116 includes one or more pages of content encoded in a markup language which invokes a Java applet that provides the functionality allowing the client computer 112 to receive content configuration information from the content provider 104.

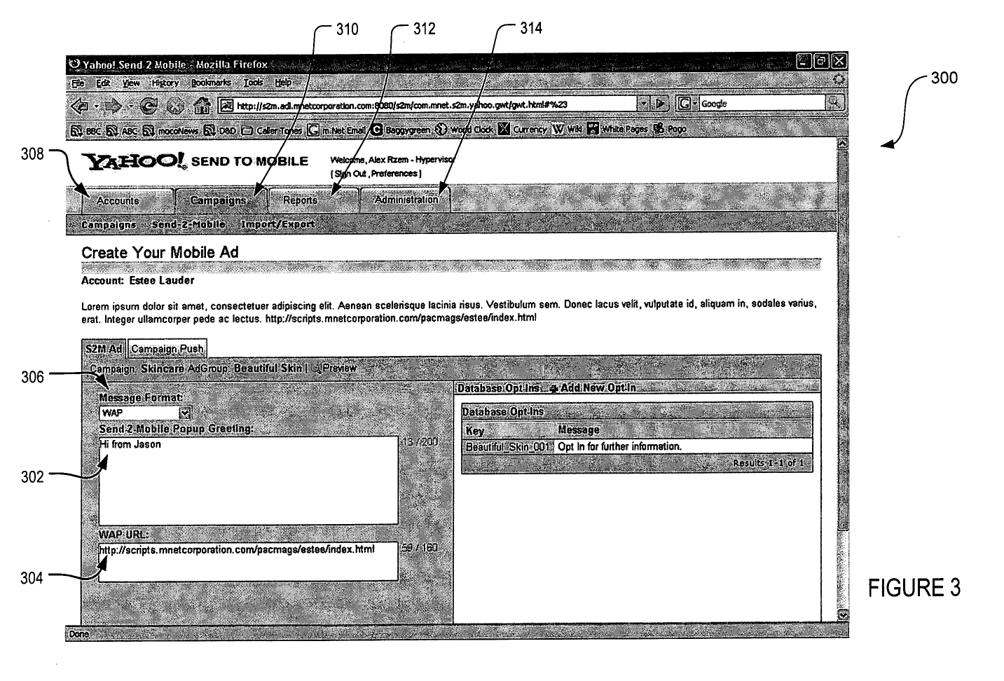

One example of a suitable webpage 300 is shown in FIG. 3.

As shown, the content configuration information may include information that specifies the presentation of the activatable control and the content for distribution to the network nodes 108. For example, the presentation information may define the size, style, type or shape of the control. In the example shown in FIG. 3, the content configuration information includes text 302 that appears on or near the control, content information 304 defining the content to be delivered on activation of the control, and service information such as communications service information 306 defining the format (for example, SMS, WAP push, email) of the content to be delivered to the nodes, business rules specifying constraints on the handling of the delivery of the content, billing and/or account information, administration information, reporting information, or administration information. In the example webpage shown in FIG. 3, the format information 306 specifies that activation of the control will initiate a WAP push.

In the webpage shown in FIG. 3, separate tabs 308, 310, 312, 314 are provided for receiving different types of content information.

In the illustrated embodiment, a content provider 104 can use the webpage 116 to configure an advertising campaign. For example, a content provider 104 may use the webpage 116 (ref. FIG. 1) to create promotional content such as advertisements, or coupons for delivery to a communications service 101 identified by a content viewer after activating the control.

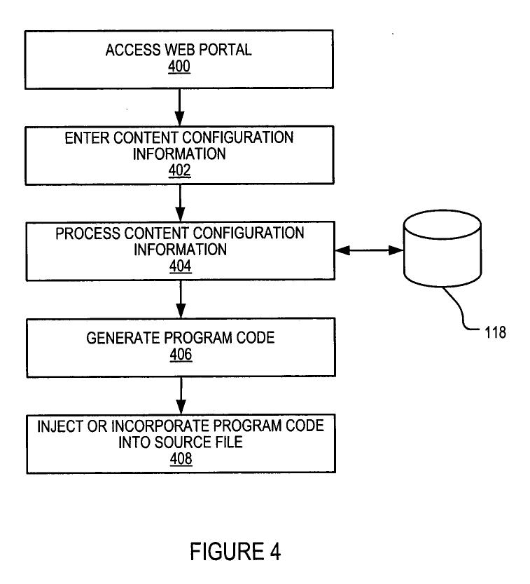

The content may include one or more of, for example, a webpage, a mobile coupon, an advertisement, a message, a URL, program code for an executable application, a Really Simple Syndication (RSS) feed, an image file item, an audio file item, or a mobile social network client. Thus, as is shown in FIG. 4, in one embodiment the content provider 104 accesses the webpage 116, at step 400, and enters, at step 402, content configuration information that dictates the type and/or appearance of content that will be delivered to a communications service 101 associated with a content viewer 111 in response to the content viewer 111 activating the control and entering an identifier for the communications service 101.

At step 404, and with reference to FIG. 1, the content configuration information relating to the properties of the activatable control (such as, for example, the size, shape, type and the like) is processed by the engine 106 to generate program code for distribution to one or more nodes 108 of a computer network 110. Content configuration information relating to the service (such as account information, content provider information, business rules and the like) is stored in the database 118 accessible to a management server 120 hosting the engine 106. As will be appreciated, the database 118 may be distributed over multiple servers or locations. In addition, other services may make other content and services available through or for the management server 120.

In FIG. 1, the engine 106 is shown installed on a management server 120 which may be any suitable type. For example, the management server 120 may include a Microsoft Internet Information System (IIS) server, an Apache server, or a Sun Microsystem Java System Webserver, or other commercial or open source Web server. It will further be appreciated that the engine 106 and other components could be coded in any suitable scripting or programming language such as Javascript, Visual Basic, Visual Basic.Net, ColdFusion, Scala, or any other suitable scripting or programming language. In the embodiment shown in FIG. 1, the engine 106 is a server side engine in that the engine is resident on the management server 120. However, in alternative embodiments the engine 106 may reside on the client computer 112 as a client side engine, in which case the program code is generated by the client computer 112.

As is shown in FIG. 1, the management server 120 and the client computer 112 are communicatively coupled via the Internet 114. However, in other embodiments the management server 120 and the computer 112 may be connected using a different arrangement, such as a local area network (LAN) or a wide area network (WAN) or the like. Furthermore, although in the illustrated embodiment the engine 106 is hosted by a single management server 120, it will be appreciated that the engine may be distributed in a modular architecture involving multiple servers.

In the embodiment shown in FIG. 1, the program code generated by the engine 106 at step 406 (ref. FIG. 4) includes executable program code which is communicated to the client computer 112 via the Internet 114. It will be appreciated that the program code could be generated in any suitable programming or scripting language, for example, Javascript, Visual Basic, Visual Basic.Net, ColdFusion, Scala, or any other suitable scripting or programming language.

As shown in FIG. 4, at step 408, the executable program code is automatically or manually injected or incorporated into the source file (such as a source file coded in a markup language) for one or more webpages for execution by the web browser of a content viewer accessing the associated website. The webpage may include a webpage directly associated with a website of the content provider (for example, the content provider's home page), or it may include one or more webpages for websites which have been selected by the management server 120 on, for example, the basis of statistical data, or by an agreement between the website owner(s) and the provider of the management services. For example, the selected website may be a website associated with an ad-network.

In an embodiment that supports the creation of an ad-network, a website owner may elect to have the activatable controls associated with one or more content providers (for example, advertisers) displayed on their site. In such an embodiment, the website owner may receive a payment which is based on the number of times that a displayed control is activated. Thus, for example, a website owner could elect to include the activatable controls of multiple content providers (for example, multiple advertisers) on a webpage associated with their website and then receive a portion of the revenue charged by the management service for each activation, or “click”, of the activatable control.

Alternatively, a profiling engine of the management server 120 may determine which activatable controls are displayed on a selected webpage of a website. A selected webpage may display more that one activatable control.

The injection or incorporating of the executable program code will typically be performed by the content provider 104, or by a person instructed by, or acting for, the content provider 114. The executable program code will encode information that is decodable by the management server 120 for indexing into the database 118 to retrieve stored content configuration information associated with the content provider 114. Suitable applications for editing a source file would be well known to a person skilled in the field of software engineering.

After the executable program code has been injected or incorporated into the source file (or source files) it can then stored on a webserver (such as web server 122) for access in a manner which permits distribution of the program code to one or more nodes of the network 110 (ref. FIG. 1), in response to a HTTP request to the URL for the website associated with the source file.

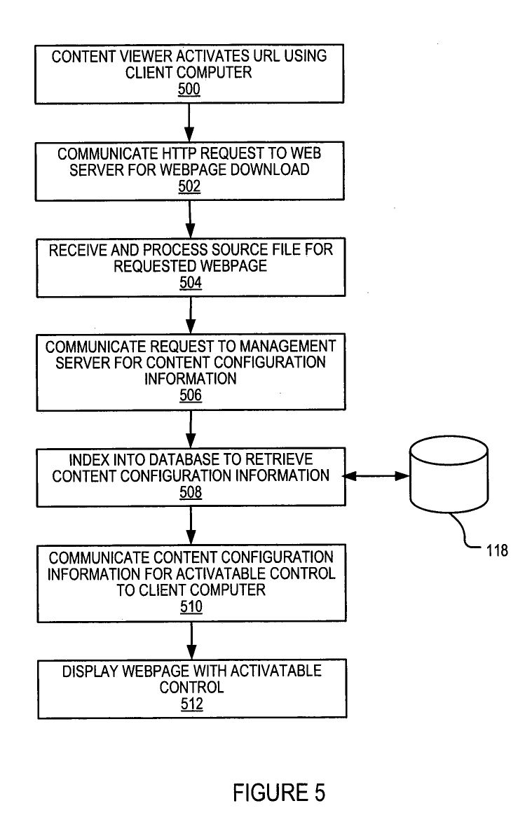

In the illustrated embodiment, activating the URL results in the program code being distributed, via networked communication, from the webserver to a client computer 122, for interpretation or execution to display the activatable control. The activatable control may include, for example, a button, a tick box, a dial, a slide control, an active area, text (for example, “press here”), an icon, an avatar, or the like. Thus, and as is shown in FIG. 5, in response a content viewer 111 activating the URL, at step 500, the client computer 122 communicates, at step 502, a HTTP request to the web server 122 (ref. FIG. 1) hosting the modified source file to request the download of the webpage 116 (ref. FIG. 1). In response to the request, the server 122 (ref. FIG. 1) sends the source file to the client computer 124, which incorporates the program code.

At step 504, the client computer 122, receives and processes the received source file, and encounters and executes the executable program code. Execution of the program code causes the client computer 122 to communicate, at step 506, a request to the management server 120 for the presentation component of the content configuration information. The request includes a database index associated with the content configuration information, which may include the communication service identifier, or an index associated with particular content configuration information.

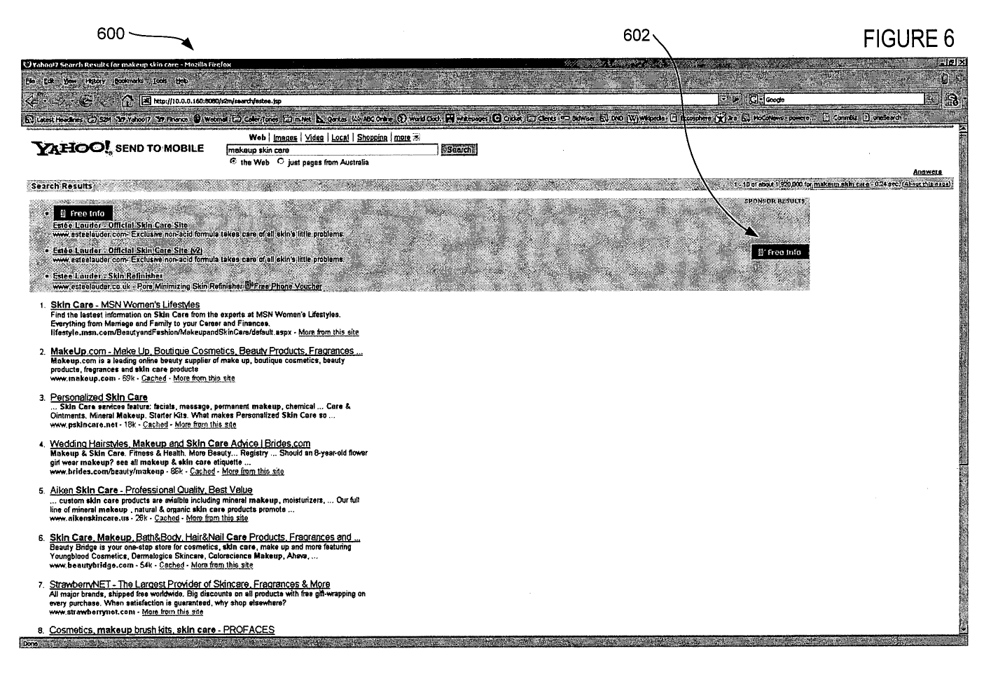

Upon receipt of the request, the management server 120 indexes into the database 118 to access and retrieve, at step 508, the content configuration information to determine, for example, whether or not, and if so how, the activatable control should be displayed on the client computer 124. If the activatable control is to be displayed (for example, if the content provider 104 has the required account credit), the management server 120 communicates, at step 510, information to the browser of the client computer 122 instructing it to display the activatable control in accordance with the content configuration information. The client computer 122 then displays the webpage, at step 512, with the activatable control. One example of a displayed webpage 600 is shown in FIG. 6. As shown, the illustrated webpage 600 includes an activatable control 602 in the form of a “button”.

As explained previously, when displayed, the activatable control 600 may be activated by a content viewer 111 to receive, as an input, a communications service identifier from the content viewer 111 and then to initiate delivery of content to the identified communications service in accordance with the content configuration information.

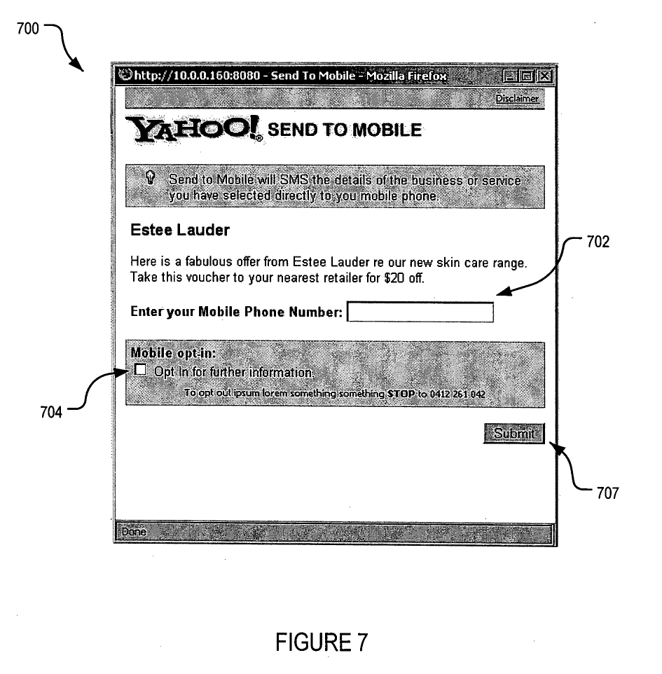

In the illustrated embodiment, the activation of the activatable control 600 causes a user input interface panel to be displayed on the client computer 112. The input interface panel will typically include one or more user input fields for receiving user input via a suitable input device such as a keyboard, mouse, tracker-ball, touch panel, joystick of the like. One example of a suitable input interface panel is shown in FIG. 7 in the form of a pop-up window 700. However, it will of course be appreciated that other types of input interface panels may be used, such as, a webpage, a form or a table or the like.

The “pop-up” window 700 shown in FIG. 7 includes an entry field 702 for accepting a communications service identifier from the content viewer. In the present case, the pop-up window also includes an “opt-in” check box 704 and a submit button 706. It will be appreciated that other entry fields may also be provided.

In the present case, the communications service identifier is an identifier for a mobile telecommunications service 126 (ref. FIG. 1), and thus the data entry field accepts information identifying a mobile phone number for that service, such as a mobile phone service 128 (ref. FIG. 1). However, it will be appreciated that the identified communications service may another type of communication services, such as, public switched telephone network 136 service (PSTN) (such as a telephone service 132 or facsimile service 130 or the like) or a packet-switched based communications service (such as a VOIP telephone service 134, or mobile internet service 140).

On activation of the submit button 706, the information identifying the communications service is communicated to management server 120 (ref. FIG. 1). In response to receiving the information, and with reference again to FIG. 1, the engine 106 of the management server 120 retrieves and processes content configuration information from the database 118 to obtain content information for communication to the identified communications service. The content and the identifier information is then communicated to a gateway 138 including suitable hardware and software to transmit information over the network associated with the identified service. The gateway 138 then transmits the content information to the device identified by the provided communications service identifier in accordance with the content configuration information.

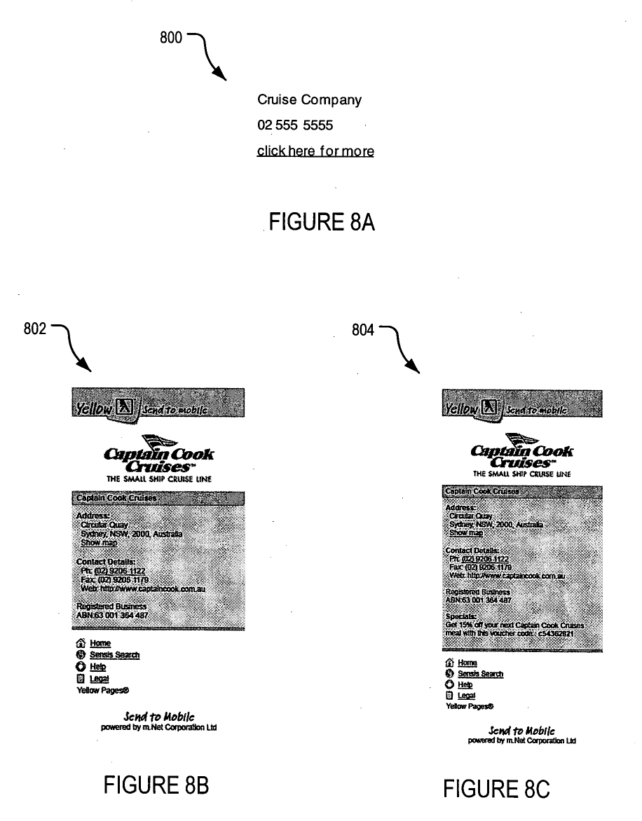

FIG. 8A, FIG. 8B, and FIG. 8C, show examples of content information for display on a mobile telephone as mobile content. It will be appreciated that the type and format of the content will vary according to the communications service 101, and be based on the content configuration information entered by the content provider 104. For example, the content may include a webpage, a mobile coupon, an advertisement, a message, a URL, program code for an executable application (such as a game), a Really Simple Syndication (RSS) feed, an image file item, an audio file item or a mobile social network client. In this respect, FIG. 8A shows an example of SMS text message, FIG. 8B shows an example of an advertisement for display on a web-enabled mobile device, and FIG. 8C shows an example of a mobile coupon for display on a web-enabled mobile device.

Referring again to FIG. 1, in an embodiment, following receipt of the information identifying the communications service 101, and prior to communicating with the gateway 138, the management server 120 performs a series of tests to determine whether the request is legitimate. The purpose of such test may include, for example, to check the status of the content provider's account, or to determine whether the communication of the information identifying the communications service might be spam. Thus, the management server 120 may perform test to identify, for example, high volume of automated requests for transmission to non-consenting handset owners. Such tests may include, for example:
A test to determine whether a “daily limit” has not been exceeded by a client computer as identified by an IP address;
A test to determine whether a “daily limit” has not been exceeded by a browser, as identified by cookies;
A test to determine whether a “daily limit” has not been exceeded by a mobile handset, as identified by phone number;
A test to determine that the communications service identifier was entered into a form which originated from the website site containing the program code and not simply sent using an automated “spambot” program (for example, by checking the Referring-URL field of the HTTP request header); and
A test to determine whether a “user-invisible” element of the user interface panel has not been filled out or activated.

In a system embodiment in which the management server 120 performs such tests, and in the event that the management server 120 detects that the communication containing the communications service identifier is likely a malicious communications (such as spam), the management service 120 will not initiate communication with the gateway 138.

### Example 1

The following describes an example sequence of the use of an embodiment of a system in accordance with the present invention to deliver web content that is activatable for delivery to a mobile communications service as mobile content.

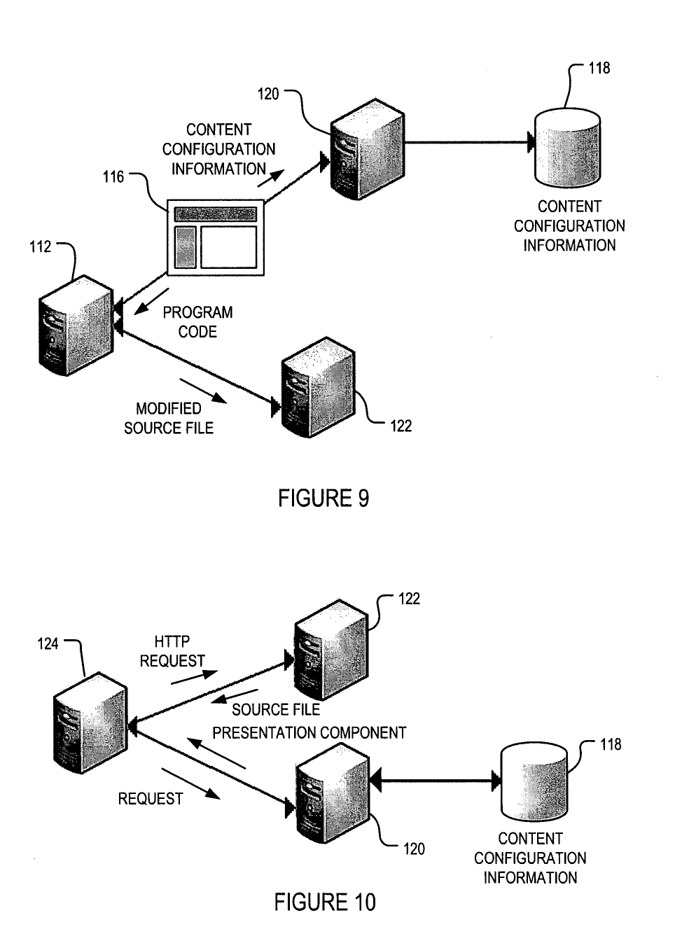

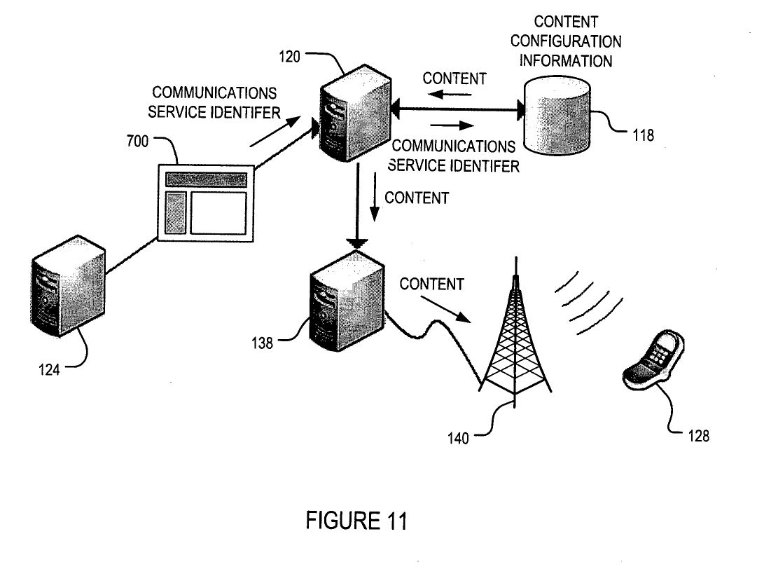

1. First, with reference to FIG. 9, a content provider uses a client computer 112 to provide content configuration information via a web interface 116 to a management server 120 regarding an activatable control, which in this case is a “button”. The information includes presentation information, such as the size/style of the button and the text to appear on/near it; and content information, such as whether the button is to initiate a WAP push or send an SMS, what the text of such an SMS is to be, or the like.
2. The management server 120 stores the presentation and content information provided by the content provider into a persistent database 118. The management server 120 generates a small quantity of executable program code (for example, Javascript) which is presented to the content provider via the web interface 116. This code is to be executed later by the web browser of a visitor to the content provider's website, or another website that has been selected by the management server 120. The code includes the necessary indexes into the database 118 to retrieve the entered content configuration information, and other details relating to the content providers account.
3. The content provider then incorporates the provided executable program code into the source file for a website, which is stored on the web server 122. Alternatively, the code is communicated third party websites selected by management server 120, perhaps on the basis of previous customer analytics.
4. With reference now to FIG. 10, a content viewer using a client computer 124, enters the URL of the website stored on the web server 122 into his browser, or clicks on a hyperlink to that website, causing his browser to send a HTTP request the web server 122. That request that the web server 122 sends to the client computer 124 computer the source file required to display the website.
5. In response to the request, the web server 122 sends the requested source file to the client computer 124. Amongst the code sent (the majority of which is not executable) is the executable program code (in this example, Javascript) into the website.
6. The web browser on the client computer 124, while processing the received code, encounters the executable program code and executes that code. The execution of the code causes the web browser to contact the management server 120 and to request (using the database index included in the Javascript) the presentation component of the content configuration information. In other words, the code is equivalent to a command to “Please send me the HTML code that tells me how display the button whose presentation details are stored at database index and the address of a popup to display when it is clicked on”.
7. The management server 120 uses the database index to determine whether or not, and if so how, the button should be displayed. In the event that the button is to be displayed (for example, in the event that the content provider has the required account credit, etc.), the management server 120 retrieves the content configuration information from the database 118 in which it was stored and communicates code back to the browser of the client computer 124 instructing it to display the button in accordance with the content configuration information.
8. The client computer 124 then displays the button appropriately in the displayed webpage.
9. With reference now to FIG. 11, the content viewer then uses the client computer 124 to enter a mobile phone number into a popup window 700 which is presented after the content viewer clicks on the “button” displayed by the browser.
10. The mobile phone number is sent to the management server 120.
11. The management server 120 performs a series of tests designed to prevent “spamming” of the system: abuse in the form of a high volume of automated requests for transmission to non-consenting handset owners
12. If the tests deem that the request is not part of a spamming campaign, the management server 120 retrieves from the database 118 the content information associated with the activated button.
13. The management server 120 then passes the mobile phone number and the content information to a gateway 138 which has the required network facilities to transmit information over a mobile network.
14. The gateway transmits the content information to the mobile handset identified by the provided phone number.

Although in the above described embodiments the invention is implemented primarily using computer software, in other embodiments the invention may be implemented primarily in hardware using, for example, hardware components such as an Application Specific Integrated Circuit (ASIC). In other embodiments, the invention may be implemented using a combination of both hardware and software.

In conclusion, it must be appreciated that there may be other various and modifications to the configurations described herein which are also within the scope of the present invention.

1. A system for creating web content that is activatable for delivery to a communications service, the system including:
an interface for receiving content configuration information from a content provider;
an engine for processing the content configuration information to generate program code for distribution to one or more nodes of a computer network, each node for executing the program code to display, on execution of the program code, an activatable control to a content viewer; and
wherein the program code is configured to respond to a content viewer activating the control to receive a communications service identifier from the content viewer and to initiate delivery of content to the identified communications service in accordance with the configuration information.

2. A system according to claim 1 wherein the interface is a web portal.

3. A system according to claim 2 wherein the web portal is associated with a web service.

4. A system according to claim 1 wherein the content configuration information includes information identifying or representing the content for delivery, and wherein the content includes one or more of:
a. text content, in the form of a text message;
b. audio content;
c. graphical content; and
d. audio visual content.

5. A system according to claim 1 wherein the content configuration information includes a message for delivery to a device associated with the identified communications service.

6. A system according to claim 1 wherein the content configuration information includes computer program code for communication to a device associated with the identified communications service for execution by the device.

7. A system according to claim 1 wherein the content configuration information includes link information identifying a web page.

8. A system according to claim 7 wherein the link information identifying a web page is a uniform resource locator (URL).

9. A system according to any claim 1 wherein the content configuration information includes information specifying business rules associated with the delivery of the web content to mobile devices.

10. A system according to claim 9 wherein the business rules specify content delivery handling constraints.

11. (canceled)

12. A system according to claim 1 wherein the execution of the program code appends the activatable control to a web page displayed by the browser.

13. (canceled)

14. (canceled)

15. A system according to claim 1 wherein the program code is configured to generate an input entry interface for receiving the communications service identifier in response to the viewer activating the control.

16. A system according to claim 15 wherein the input entry interface is a web pop-up.

17. A system according to claim 15 wherein the input entry interface is configured to receive an opt-in selection signal from the viewer.

18. A system according to claim 1 wherein the content delivered to the identified communications service is configured to be executable or interpretable by a device associated with the communications service so as to activate the content.

19. A system according to claim 18 wherein the content includes one of:
a. a web-page;
b. a mobile coupon;
c. an advertisement;
d. a message;
e. a URL;
f. program code for an executable application;
g. a Really Simple Syndication (RSS) feed;
h. an image file item;
i. an audio file item; and
j. a mobile social network client.

20. A system according to claim 19 wherein the message includes one of:
a. a short message service (SMS) message;
b. a multi-media service (MMS) message; and
c. an email message.

21. A system according to claim 1 wherein the computer network is an ad network.

22. A system according to claim 1 wherein the identified communications service includes one of:
a. a public land mobile network service (PLMN);
b. a public switched telephone network service (PSTN); and
c. a packet-switched based communications service.

23. (canceled)

24. (canceled)

25. (canceled)

26. (canceled)

27. A computer readable media storing a computer software program, the computer software program being executable by a computer to cause the computer to be operable by a content provider to create web content that is activatable for delivery to a communications service device by:
providing an input interface receiving content configuration information from the content provider;
providing an engine for processing the configuration information to generate program code for distribution to one or more nodes of a network, each node for executing the program code to display, on execution of the program code, an activatable control to a viewer; and
wherein the program code is configured to respond to a viewer activating the control to receive a communications service identifier from a viewer and to initiate delivery of content to the identified communications service in accordance with the content configuration information.

28. A system for distributing web originating content to nodes of a computer ad network, the web content being activatable for delivery to an identified mobile communications service, the system including:
a web portal for creating web content in the form of an advertisement for delivery to a mobile device associated with a mobile communications service, the web portal including:
an interface for receiving content configuration information from a content provider;
an engine for processing the content configuration information to generate program code for distribution to one or more nodes of the ad network, each node for executing the program code to display, on execution of the program code, an activatable control to a viewer; and
wherein the program code is configured to respond to a viewer activating the control to receive, from the viewer, a mobile communications service identifier for a mobile device associated with the mobile communications service, and to initiate delivery of the advertisement to the mobile device service in accordance with the configuration information; and
one or more network nodes for receiving the program code, each node including a browser for executing the program code.

29. (canceled)

30. (canceled)

31. A client computer including a processor, an associated memory, and a computer software program resident in the memory, the computer software program being executable by the processor to cause the computer to be operable by a content provider to create web content that is activatable for delivery to a communications service by:
providing an input interface for receiving content configuration information from the content editor;
providing an engine for processing the configuration information to generate program code for distribution to one or more nodes of a network, each node for executing the program code to display, on execution of the program code, an activatable control to a viewer; and
wherein the program code is configured to respond to a viewer activating the control to receive a communications service identifier from a viewer and to initiate delivery of content to the identified communications service in accordance with the content configuration information.

32. A server computer including a processor, an associated memory, and a computer software program resident in the memory, the computer software program being executable by the processor to cause the computer to be operable by a content provider to create web content that is activatable for delivery to a communications service by:
receiving content configuration information from a client computer operated by a content editor;
providing an engine for processing the configuration information to generate program code for distribution to one or more nodes of a network, each node for executing the program code to display, on execution of the program code, an activatable control to a viewer; and
wherein the program code is configured to respond to a viewer activating the control to receive a communications service identifier from a viewer and to initiate delivery of content to the identified communications service in accordance with the content configuration information.

33. A method of creating web content that is activatable for delivery to a communications service, the method including:
an input interface receiving content configuration information from a content provider; and
an engine processing the configuration information to generate program code for distribution to one or more nodes of a network, each node for executing the program code to display, on execution of the program code, an activatable control to a viewer;
wherein the program code is configured to respond to a viewer activating the control to receive a communications service identifier from the viewer and to initiate delivery of content to the identified communications service device in accordance with the content configuration information.

34. A method according to claim 33 further including distributing the program code to the one or more nodes of the network.

35. An ad-network including activatable controls created using a method according to claim 33 wherein a created activatable control is selectable for inclusion in a website associated with a website owner, and wherein upon selection for inclusion the executable program code is automatically or manually injected or incorporated into the source file for one or more webpages of the website.

36. (canceled)

37. (canceled)
